(19) United States
(12) Patent Application Publication
(10) Pub. No.: US 2026/0243602 A1
(43) Pub. Date: Aug. 20, 2026

(54) OPTICAL SPECTROMETER

(71) Applicant: UNIVERSITY OF SOUTH FLORIDA, TAMPA, FL (US)

(72) Inventor: Andreas Muller, Tampa, FL (US)

(21) Appl. No.: 19/460,923

(22) Filed: Jan. 27, 2026

Related U.S. Application Data
(60) Provisional application No. 63/759,476, filed on Feb. 17, 2025.

(51) Int. Cl. G01J 3/18; G01J 3/02; G01J 3/28; G01J 3/44; G01N 21/65

(52) U.S. Cl. CPC G01J 3/18; G01J 3/0208; G01J 3/2803; G01J 3/2823; G01J 3/4412; G01N 21/65

(57) ABSTRACT

A refractive optical grating spectrometer employing a single bidirectionally utilized lens, having a spectral resolution of about 1.4 cm⁻¹ over a spectral range of about 3800 cm⁻¹ and, in one implementation, operate without moving parts. The single lens is traversed by both the input light and the light already dispersed by the diffraction grating. The spectrometer offers high detection efficiency (>50% in the green portion of the optical spectrum, for p-polarized light), high spectral range-to-resolution ratio (>3000) and low noise, and has an exceptionally compact (under 2 liters) spatial volume and a near-diffraction-limited spot size on the detector. With small detection areas (on the order of 10-100 pixels per peak), thermal noise becomes negligible and thermoelectric cooling unnecessary, requiring only USB power. A Raman spectroscopic system employing the same.

### CROSS REFERENCE TO RELATED APPLICATIONS

This application claims the benefit of U.S. Provisional Patent Application No. 63/759,476, filed on Feb. 17, 2025 and titled “Low-Noise Optical Spectrometer with High Spectral-Range-to-Resolution Ratio.” The entire contents of which are hereby incorporated by reference herein.

### STATEMENT REGARDING FEDERALLY SPONSORED RESEARCH OR DEVELOPMENT

This invention was made with government support under Grant Number 2116275 awarded by the National Science Foundation. The U.S. government has certain rights in the invention.

### TECHNICAL FIELD

The present invention relates to optical spectrometers in general and, more particularly, to a diffractive grating spectrometer the optical imaging system of which employs a single (only one, not one of several) lens that is used bidirectionally both for collimating the input light and for refocusing the grating-dispersed light onto in an image space—thereby offering an exceptionally spatially compact solution with near-diffraction-limited spot sizes on the detector.

### RELATED ART

Long before the advent of the laser, the ability to decompose light into its constituent spectral components had already enabled the characterization of atoms and molecules, and led to significant advancements in fields such as chemistry, cosmology, geology, to name a few. Today, spectrometers are essential tools, with applications spanning across industry, astronomy, and broad areas of laboratory research.

The ideal optical spectrometer has high spectral selectivity (i.e., spectral resolution), wide spectral range, low noise, high dynamic range, high speed, high linearity, and high detection efficiency. In addition, a portable device should be compact, durable, and require/dissipate as little power as possible. A skilled artisan will readily appreciate that all these properties cannot be maximized simultaneously and that how well these properties can be represented depends, in most spectrometers, upon the two main spectrometer components: (i) a frequency-selective element and (ii) an optical detector.

Apart from somewhat unique ultra-high resolution (Δf≲kHz) homodyne/heterodyne laser spectral characterization devices, the frequency-selective element in an optical spectrometer is typically an optical cavity (such as, for example, in a Fabry-Perot spectral analyzer), an interferometer, or a dispersive optic (such as a prism or a diffraction grating). As evidenced by related art, cavity-based spectrometers may employ a simple monolithic optical etalon (an interference filter, see T. Kieft, et al., Rev. Sci. Instruments 93, 035102 (2022)) or a more complex element such as a ring resonator, a Fizeau etalon, or a virtually-imaged phased array (VIPA, see M. Shirasaki, Opt. Lett. 21, 366-368; 1996) with characteristically high resolution Δf ranging from a kHz range to a GHz range) but a limited spectral range. Alternatively, interferometry-based spectrometers such as Fourier-transform infrared spectrometers (FTIR; see J. W. Brault, Appl. Opt. 35, 2891-2896; 1996), and spatial heterodyne interferometers (see, for example, G. Németh and Áron Pekker, Opt. Express 28, 22720-22731; 2020) typically feature lower resolution (Δf~THz) but boast a much greater spectral range.

As is well recognized, an often-acceptable compromise between spectral resolution and spectral range is offered by a diffraction grating based spectrometer (most commonly implemented in a Czerny-Turner design, which has been the workhorse not only in scientific setups but also in portable USB-based devices). The Czerny-Turner spectrometer is versatile, highly achromatic due to the use of spherical mirrors, and provides high throughput despite generally suffering from astigmatism and coma (see, for example, M. V. Murty, in Opt. Eng. 13, 123, 1974; D. R. Austin, et al., in Appl. Opt. 48, 3846-3853; 2009). When such spectrometer is used in conjunction with an array detector, high detection efficiency can be achieved (which is highly desired in low-light applications such as photoluminescence spectroscopy, astronomy, single-photon imaging, Raman spectroscopy, or laser-induced breakdown spectroscopy).

The major flaw of a Czerny-Turner-type spectrometer stems from the fact that its spectral resolution is largely dictated by its overall size. Even astigmatism-free variants, including those employing curved gratings (see Q. Zhou, et al., Appl. Opt. 54, 9450-9455, 2015), cannot be easily scaled down, and the spot size of light on the final array detector is typically large, implying and resulting in high thermal noise. In scientific applications, this issue is most often circumvented by thermoelectrically cooling the detector to temperatures around −50° C. to suppress the thermal noise and by making the instrument vary large (~a meter scale). Understandably, however, that demands on heat-dissipation, power consumption, and weight are features incompatible with portability—which is desperately required.

Various grating spectrometers engineered for portability have been developed. Nevertheless, many applications—such as trace gas Raman scattering, for example—require not only portability of the spectrometers but also the ability to detect extremely faint light (on the order of 100 photons per second) at high spectral resolution (few units of a wavenumber or even less). For such specific applications, thermoelectric cooling as a means of reaching the desired level of sensitivity is highly undesirable because of the amount of electrical power consumed by Peltier elements. A way around the use of Peltier coolers is to dramatically reduce the detection area (the person of art knows well that thermal noise scales with photoreceptor area), which can be achieved with the use of high numerical aperture optics. At the same time, however, the reduction of the detection area must not come at the expense of the spectral range of operation of the spectrometer (which is related primarily to the focal length of the used optics)—and there comes a trade-off, as large focal length and high numerical aperture are particularly difficult to achieve at the same time. (For Czerny-Turner designs, for example, the use of high numerical aperture systems implies large propagation distances and large mirrors, and therefore, high overall spectrometer footprint.)

FIGS. 1A, 1B, 1C, 1D provide an overview of some common spectrometer designs employing diffraction gratings. These include the traditional (FIG. 1A) and the crossed (FIG. 1B) Czerny-Turner designs (see, J.-R. Sze and A.-C. Wei, Appl. Spectrosc. 72, 776-786, 2018) utilizing a planar diffraction grating, as well as the Rowland circle spectrometer that uses a curved grating (FIG. 1C).

Instead of using curved reflective mirrors, refractive optical elements (such as camera lenses) can also be used for collimation and focusing. Modem camera lenses offer highly achromatic designs and those sold for consumer products, particularly in photography, are versatile, accessible, and affordable. One use of camera lenses is that in holographic transmission spectrometers (FIG. 1D; see also L. Dickson, et al., U.S. Pat. No. 8,537,466 or Z. Huang, et al., in 5th International Symposium on Advanced Optical Manufacturing and Testing Technologies: Optical Test and Measurement Technology and Equipment, vol. 7656 of Society of Photo-Optical Instrumentation Engineers (SPIE) Conference Series Y. Zhang, J. Sasiin, L. Xiang, and S. To, eds., 2010, p. 76566P). which have been commercialized primarily for use in the near-infrared. For example, HG10 sold by Thorlabs is a single-mode-fiber (5 micron mode field diameter) based instrument providing a spectral range of 1983 cm⁻¹ (from about 10363 cm⁻¹ to about 12346 cm⁻¹) and spectral resolution of 3.16 cm⁻¹ (available at https://www.thorlabs.com/newgrouppage9.cfm?objectgroup_id=15359). It occupies a volume of about 4 liters. A more compact model employing a transmission diffraction grating (EAGLE C-OCT-S) was recently commercialized for applications in optical coherence tomography by Ibsen Photonics (available at https://ibsen.com/productinfo/compact-eagle-oct/). It is configured to cover a narrower spectral range of (851 cm⁻¹) from about 11494 cm⁻¹ to about 12345 cm-1 but at a higher spectral resolution of 0.8 cm⁻¹ and occupies a volume of under 1 liter. However, neither of these two spectrometers is capable of handling low-light applications. Further, each of these spectrometers can achieve the stated spectral resolutions only when input light is delivered via a single mode optical fiber.

An effective approach that forgoes single mode fiber coupling has been devised in the form of the use of a spatial heterodyne interferometer in a spectrometer apparatus. Such apparatus are commercialized, for example by LightMachinery (see U.S. patent application Ser. No. 16/503,885) and feature spectral range and resolution similar to those of a holographic grating spectrometer. However, the spatial heterodyne interferometer based spectrometers rely on formation of extended fringe patterns on an array detector and thus are even harder to adapt to low-light measurements than other spectrometer implementations.

### SUMMARY OF THE INVENTION

Embodiments of the invention provide an optical spectrometer that includes a single—the only—lens, an input, and an optical imaging system that contains a diffractive optical element and such single lens between the input and the diffractive optical element (to have light, received by the spectrometer through the input, propagate to and reach the diffractive optical element through the single lens). Notably, the single lens of the spectrometer is configured to transmit light acquired by the spectrometer at the input both (i) upon propagation of the light from an object space of the optical imaging system to the diffractive optical element and (ii) upon propagation of the light that has diffracted at the diffractive optical element to an image space of the optical imaging system. Structurally, the same outer surface of the single lens limits both an object space of the optical imaging system and an image space of the optical imaging system. A Raman gas sensor apparatus including an embodiment of the optical spectrometer.

Embodiments of the invention additionally provide a method according to which, with the use of an embodiment of the optical spectrometer alluded to above, the light (received at the input) is transmitted through the single lens in a first direction upon propagating the light from the input towards the diffractive optical element; and further, having diffracted at the diffractive optical element, is traversed through the same single lens in a second direction that is opposite to the first direction. A method may additionally include a step of forming an optical image of a distribution of the light at the input at an optical detector of the spectrometer with a first magnification that is substantially a unit magnification along a first axis (which first axis lies in a plane of the optical detector) and with a second magnification that is different from the first magnification along a second axis (which second axis lies in the plane of the optical detector) where the first and second axes are substantially normal to one another. At least in one specific case, implementation of an embodiment of the method does not involve moving or repositioning of a component of the optical spectrometer.

### BRIEF DESCRIPTION OF THE DRAWINGS

The invention will be more fully understood by referring to the following Detailed Description of Specific Embodiments in conjunction with the Drawings, of which:

FIGS. 1A, 1B, 1C, 1D present schematics of conventional spectrometer designs. The light introduced into a given spectrometer through a narrow slit (as shown) can only be delivered via a pinhole or an optical fiber. FIG. 1A: Czerny-Turner configuration; no lens element is used. FIG. 1B: Crossed Czerny-Turner configuration; no lens element is used. FIG. 1C: Rowland circle configuration; no lens element is used. FIG. 1D: Configuration employing a diffractive grating in transmission; each of the employed lenses or lens elements is used in transmission of light only once—upon propagation of light from the input towards the array detector.

FIG. 2A: A schematic an embodiment of the invention employing a single (that is, the only one, not one of several) bidirectional lens and a diffractive optical element (here shows as a diffraction grating). PC/processor may be optionally employed to govern the operation of constituent components of the embodiment and/or collect and store acquired data. FIG. 2B: a schematic of the embodiment substantially similar to that of FIG. 2A explicitly showing a single multi-lens-element lens (a camera lens) used for forming an image of the spectrometer input on a plane of the optical sensor/detector.

FIG. 3: Discrete line spectra analysis. The spectrum identified as 300 is that of an argon laser near threshold while the spectrum 310 corresponds to a neon lamp. The wavelengths indicated are those extracted from the peak locations after calibration. The inset contains a zoomed view of the peak at 533.086 nm and its resolution-limited full width at half maximum (FWHM) is 33 pm (1.2 cm⁻¹).

FIG. 4: Spectrum of diffusely scattered sun light recorded with an embodiment of the invention (top trace). It was baseline-adjusted, normalized and inverted to be compared to the high-resolution data from the Observatoire de Paris repository data (bottom trace). The hydrogen Balmer H-β line is labeled and other characteristic lines are also easily identifiable.

FIG. 5: Raman spectrum of ambient air for an exposure time of 2 s (labelled 400) and 100 s (labelled 410), recorded with an embodiment of the invention. The wavelength range covered was from 458 nm to 551 nm. The pump laser wavelength was 442 nm (22624 cm-1). The inset shows a zoomed view of the same data.

FIG. 6 illustrates an embodiment of the invention with an optical imaging system that contains containing optically cascaded diffractive optical elements and a camera lens.

FIG. 7 is a schematic of Raman das spectroscopic system utilizing an embodiment of the optical spectrometer configured according to the idea of the invention.

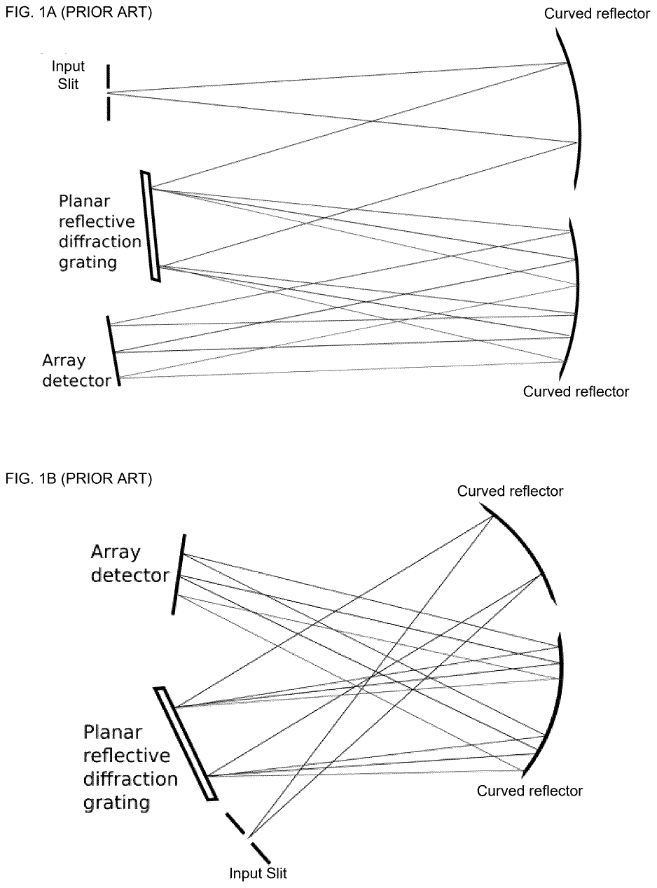

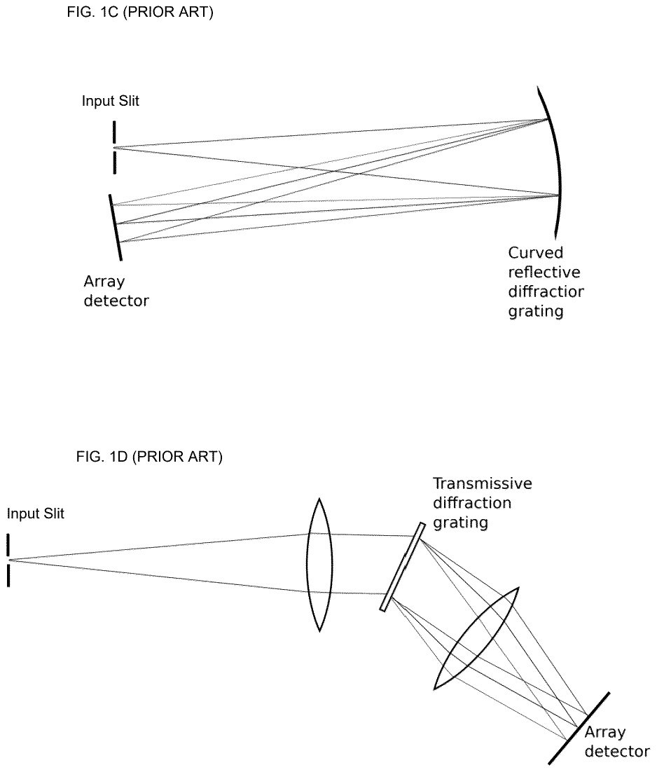

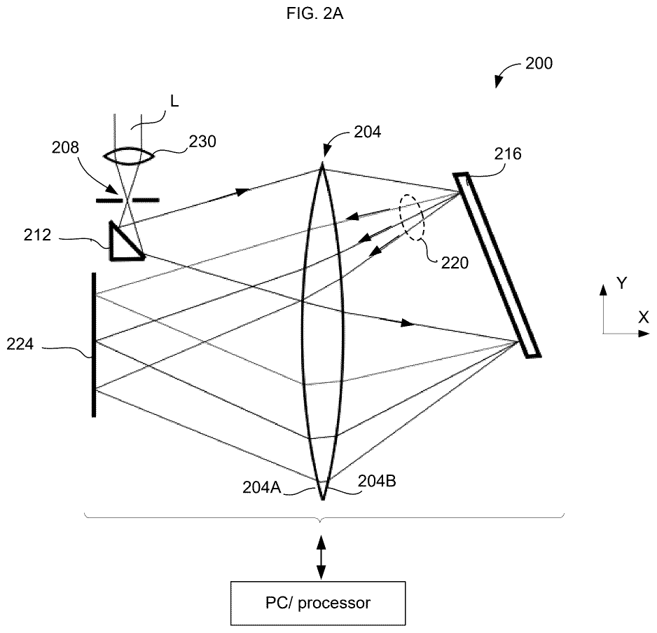

### DETAILED DESCRIPTION

In accordance with embodiments of the present invention, methods and apparatus are disclosed for an optical grating spectrometer with operational characteristics greatly improved over those of the conventional Czerny-Turner designs. An embodiment is based on using, in an optical imaging system of the embodiment, a single fast lens the same surface of which faces both the object space and the image space of the optical imaging system and that is employed bidirectionally: both for collimating the input light before delivering it to a diffractive optical element of the optical imaging system and for refocusing the light dispersed at such diffractive optical element at a plane located in the image space (such as, for example, a plane of an array detector). This approach offers an exceptionally compact solution with near-diffraction-limited spot sizes on the detector. With detection areas that are very small (on the order of 10-100 pixels per peak), thermal noise becomes negligible and thermoelectric cooling unnecessary, requiring only USB power. Non-limiting examples are discussed in which an embodiment utilizes a conventional diffraction grating as a diffractive optical element and in which the spectrometer's high spectral range-to-resolution ratio (>3000) is a determinant feature. Most critically, light-starved applications such as spontaneous Raman scattering in gases stand to benefit from such a spectrometer because it can unlock potential for portability.

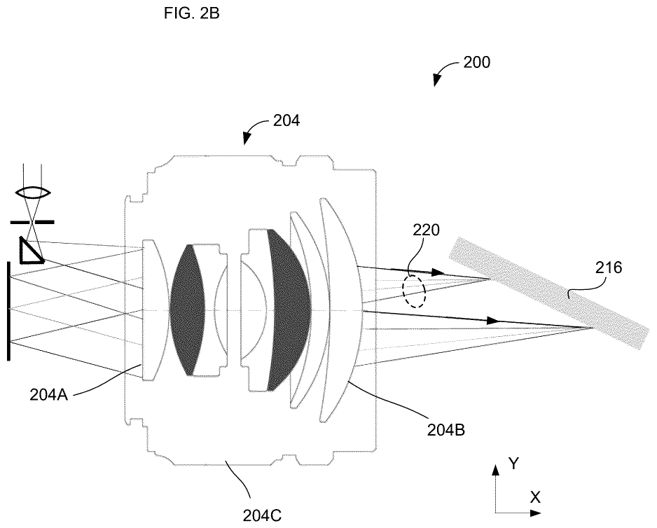

One non-limiting embodiment 200 of the proposed structure is schematically illustrated in FIG. 2A. It makes use of a single fast lens 204 (shown in this example, for simplicity of illustration, as a single lens element) that has a front surface 204A a rear (or back) surface 204B. The complementary schematic of FIG. 2B illustrates a more complex incarnation of the single lens 204, this time—shown as a single multi-lens-element lens, in particular a single camera lens Artisans F0.95/50 mm contained in a lens housing 204C). As a result of having a large aperture, the single lens 204 has space off-axis for physically accommodating large beams of light and is characterized by particularly high transmission of visible light (>90% in the green portion of the spectrum).

In this example, light L to be analyzed is introduced through an input 208 of the spectrometer—here, a slit 208, as in many grating-based spectrometers—and is deflected by a 3 mm-long right-angle prism reflector 212 (Thorlabs MRA03-E02) toward the lens 204, preferably in such a fashion as to propagate nearly through the center of the lens 204. A reflective 25 mm×25 mm 2400 grooves/mm diffraction grating 216 (Newport 33009FL01-430H) is used as a diffractive optical element 216 positioned in the object space behind the lens 204 (with respect to the input of the spectrometer 200—and oriented near its Littrow angle (that is, approximately in a Littrow configuration with respect to the light L incident onto the diffractive element 216). The diffractive optical element 216 disperses the light (in the plane of the Figure, as shown) to have light 220 (shown here as a combination of rays of light in red, green, and blue spectral regions, diffracted in the first order, when the input light L is polychromatic) form, in the image space of the spectrometer 200, corresponding optical image(s) of the spatial distribution of light L in the plane of the optical input 208 by having the light 220 focused with the lens 204 onto a two-dimensional optical array detector or optical sensor 224. The detector 224 is separated from the diffractive optical element 216 216 by the lens 204).

The diffractive optical element(s) may spatially stretch the cross-section of the beam of light (and, therefore, the corresponding refocused spot of light), as will be understood by a skilled person. For example, in the orthogonal direction (along the local Z-axis, as shown), the image of the slit 208 in non-spectrally-dispersed input light L is formed substantially without magnification on the sensor surface of the detector 224. Along the y-axis, the optical images of the input (slit 208 in this case) formed at each of the spectral components of the input light L are scaled down as compared to the corresponding dimension of the slit 208 because of the tilt of the grating 216 with respect to the detector 224 (which grating, therefore, produces the diffracted beam 200 that is wider at the front, facing the grating, surface of the lens 204 than the incoming beam L). Thus, when the input light L is monochromatic and is focused to a point on the plane of the slit 208, the optical image formed by the lens L on the plane of the sensor 224 is represented by a slightly vertically elongated spot.

The above-described optical image formation occurs when the distance between the (camera) lens 204 and the plane of the sensor 224—that is, the image distance—is substantially equal to the back focal length of the single lens 204, and when, simultaneously, the distance between the lens 204 and the input 208 (here, the slit) along an axis of the propagating light is substantially equal to the front focal length of the single lens 204. (The appropriate geometrical adjustment can be performed by first ensuring that the lens 204 completely focuses incoming collimated light when the diffractive optical element 216 is removed. Then the position of the slit 208 can be adjusted to optimize the focus of light entering through the slit.) It is appreciated that the optical imaging system of the embodiment 200 includes the lens 204 and the diffractive element 216, that—in operation of the embodiment 200—the same surface 204A of the single lens 204 limits both the object space and the image space, and that the single lens 204 is traversed by light received by the embodiment 200 through the input 208 twice—first upon propagation of such light from the input to the diffractive optical element and again upon propagation of such light from the diffractive optical element towards the image space.

Since slits are available that have widths down to a few microns, the spectral resolution that is achievable with the embodiment 200 is limited by dimensions of a detector pixel (which can be submicron, in commercially available array detectors). To maximize the ratio of operational spectral range to spectral resolution, for the embodiment 200, the most relevant metric is the ratio of the horizontal (along the Y-axis) width of the array detector 224 to the width of an individual pixel of such array detector. A good compromise is achieved by the Sony IMX183 CMOS sensor utilized in this work, that featured 5496 horizontal pixels with widths of only 2.4 microns.

During the optical alignment care was taken for having the slit 208 be movable axially while preserving the position of the slit relative to an external light focusing element 230. In at least one specific case, such focusing element 230 was a microscope objective with high numerical aperture (NA) of 0.57. Alternatively, the element 230 can be configured as a fast camera lens or other high NA value. In practice, the slit 208 as first positioned onto an attachment to the microscope objective 230 so that collimated light L entering the objective 230 were maximally transmitted through the slit 208. The attachment was then permanently bonded to the objective 230 using an adhesive. With the right choice of components, and for p-polarized light (with the polarization vector substantially perpendicular to the direction of grooves of the grating 216), the embodiment 200 of the spectrometer has high throughput. Efficiencies for the components described above are itemized in Table 1 for a wavelength of approximately 500 nm.

TABLE 1
Efficiencies of components of embodiment 200 at about 532 nm.

| | Fold | Camera | Diffraction | CMOS | |
|---|---|---|---|---|---|
| | mirror | lens | grating | detector | Overall |
| Efficiency | 97% | 93% | 83% | 80% | 55% |

The overall achieved efficiency was greater than 50% at the chosen wavelength of 532 nm. For s-polarized light, the grating efficiency, and thus the overall detection efficiency, dropped by about half. Data in Table 1 do not account for losses introduced by the slit 208 or by the optical element 230 used to focus light L on the slit. While the transmission of the latter can be over 90%, transmission through the slit 208 generally depends on how the light is delivered. Various configurations were explored to achieve this delivery in an optimal manner towards the reflector (also referred to herein as a fold mirror) 212. In one alternative and related implementation (not shown in Figures for simplicity of illustrations), input light L was delivered through a 50 micron core step index fiber (Thorlabs M42L02), collimated with a reflective collimator with a focal length of 15 mm (Thorlabs RC04FC-P01), and the focused onto the slit 204 with an alternative version of the lens element 230 having a focal length of 3.6 mm. In this case, the net transmission of light through the slit 208 was greater than 70% at a wavelength of 488 nm.

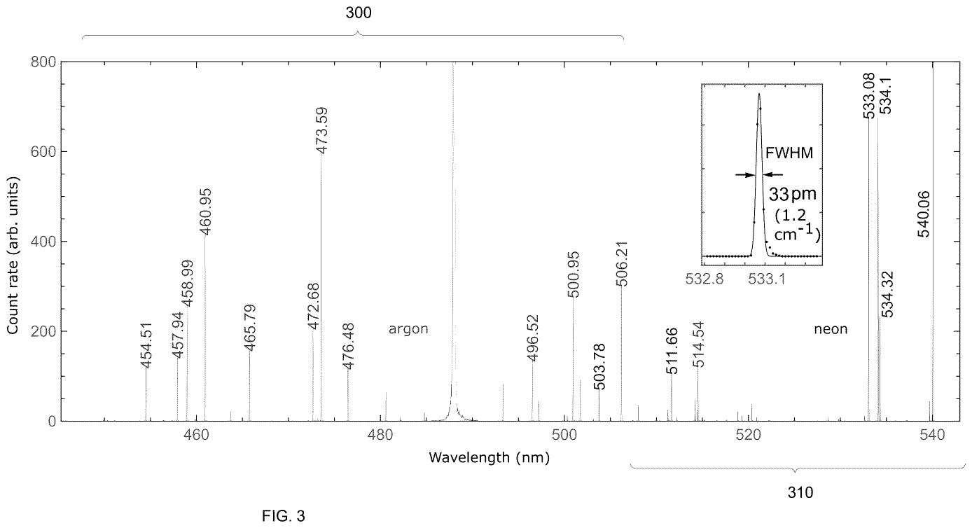

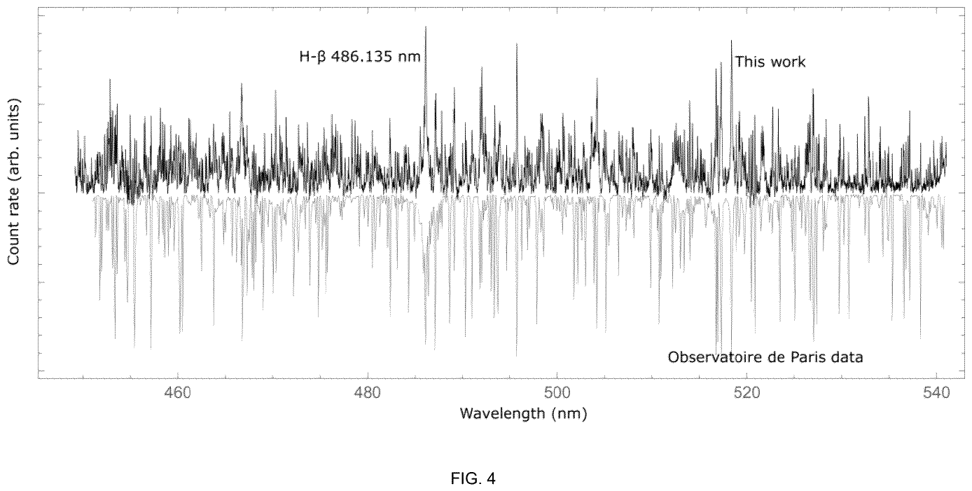

The embodiment of the invention was characterized via measurements employing atomic spectral lamps. FIG. 3 shows the spectrum of an argon laser near threshold (trace 300), and the spectrum of a neon lamp (trace 310). For these measurements, the light to be analyzed was first coupled into a multimode optical fiber delivering it to the slit with the intermediary of a collimator, two steering mirrors, and a microscope objective. With the help of the National Institute of Standards and Technology (NIST) spectral database (available at https://physics.nist.gov/PhysRefData/ASD/lines_form.html), a polynomial calibration was applied using the spectral locations of the peaks indicated in FIG. 3. The full width at half maximum (FWHM) of each of these peaks was also extracted by least-squares fitting with a gaussian function. The root-mean-square deviation between the NIST-reported line centers and the measured line centers after calibration was 7 μm. The line FWHM varied around a mean of about 35 pm (1.4 cm-1). A subset of these values is reported in Table 2, revealing that there was no obvious reduction of the resolution or the spectral accuracy at the edges. In the inset of FIG. 3, a zoomed view of a particular peak, characterized by a FWHM of 33 pm (1.2 cm-1), is shown.

TABLE 2
Nominal (NIST) and measured spectral locations, their deviations,
and fitted FWHM of some of the peaks indicated in FIG. 3.

| | | | | | | | | | | | | |
|---|---|---|---|---|---|---|---|---|---|---|---|---|
| NIST (nm) | 454.505 | 458.99 | 465.79 | 473.591 | 480.602 | 496.508 | 500.933 | 506.204 | 508.038 | 514.494 | 533.078 | 534.328 |
| Meas. (nm) | 454.501 | 458.989 | 465.796 | 473.591 | 480.599 | 496.513 | 500.941 | 506.21 | 508.026 | 514.488 | 533.086 | 534.324 |
| Dev. (pm) | −4 | −1 | 6 | 1 | −3 | 5 | 8 | 6 | −13 | −5 | 8 | −5 |
| FWHM (pm) | 35 | 40 | 43 | 37 | 33 | 40 | 40 | 36 | 27 | 17 | 33 | 34 |

The slight asymmetry observed in the inset peak, also observed in others, was attributed to the residual aberrations of the camera lens. Overall, the covered spectral range of operation was from about 449.16 nm (22264 cm⁻¹) to about 541.04 nm (18483 cm⁻¹), with a span of about 3781 cm⁻¹. Therefore, the average demonstrated spectral-range-to-resolution ratio was about 2700, limited ultimately by the CMOS sensor (array detector) 224 itself. The skilled artisan will readily appreciate that the demonstrated operational capabilities of the embodiment 200 lend such spectrometer to inspection of complex spectra with high absolute accuracy. In one practical example, the spectrum of outdoor light was recorded with an embodiment of the invention similar to the embodiment 200 but implemented with the same fiber-coupled input as that employed during the calibration measurements discussed above. is the measured spectrum is plotted in FIG. 4 after the baseline correction, normalization, and inversion. The multiple peaks do not represent noise, but instead originate due to atmospheric and solar absorption. For example, the hydrogen H-β Balmer line at 486.135 nm is clearly identified (zoomed view). High-resolution ground solar spectral data retrieved from the Observatoire de Paris data repository (available at https://bass2000.obspm.fr/solar_spect.php) is shown for comparison, and many common features can be seen. The skilled person will readily appreciate that the top trace and the bottom trace spectra are only expected to partially overlap, because of the atmospheric variability of the amplitude of individual telluric lines.

Notably, the potential influence of scattered light generated by the many residual interface reflections inside the complex multi-element camera lens 204 of the embodiment of the spectrometer was suppressed by the highly localized detection: any stray light generated inside the lens was diffuse and, for that reason, not tightly focused onto the array detector 224. This could be best verified by measurements on light sources that combine spectral features of widely varying intensity. For example, the trace 300 in FIG. 3 substantially represents the optical spectrum of an argon laser with the line at 487.99 nm being vastly more intense than all the others. Yet, it was possible to clearly measure nearby spectral features of substantially smaller magnitudes.

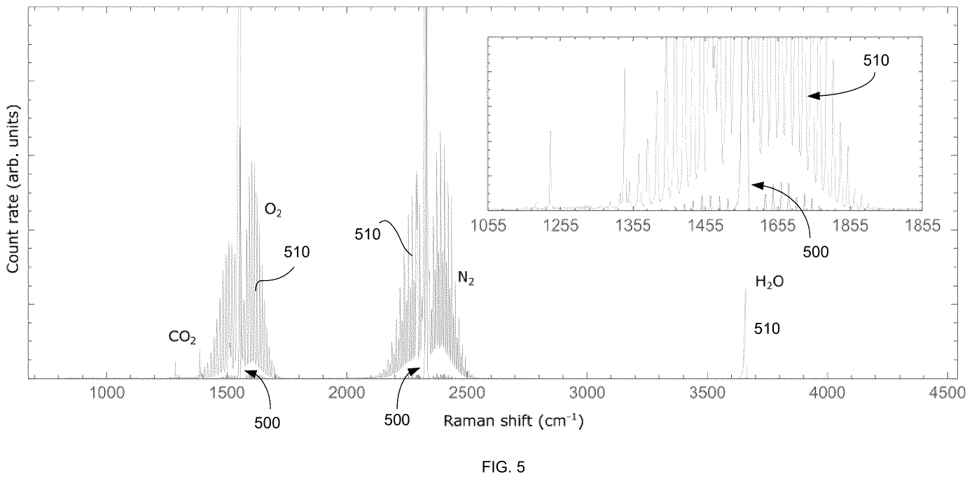

In another example, the spontaneous Raman spectrum of ambient air was measured, revealing the capability of the proposed embodiment of the spectrometer to detect faint light. It is known that spontaneous Raman scattering for gases is characterized by interaction cross sections that are of order of 10⁻³¹ cm²/sr, which cross sections are much lower than those for, e.g., fluorescence processes. Shown in FIG. 5 is the air Stokes spectrum for two different exposure durations (2 s and 100 s, represented, respectively, with plots 500 and 510). Plotted is the count rate as a function of Raman shift, i.e., the difference between the frequency of the pump laser and the frequency of Raman scattered light. The wavelength range covered in this measurement was from about 458 nm to about 551 nm. The wavelength of the pump laser was 442 nm. The continuous-wave laser source power was 2 W and a multi-pass cavity of the laser source provided an enhancement of light collection and effective circulating power. Unlike in the measurements the results of which are shown in FIGS. 3 and 4, during this measurement the coupling of input light L into the embodiment of the spectrometer was done without an intermediate fiber. The Raman scattered light generated inside the multi-pass cavity was collimated and focused onto the spectrometer slit 208 in free space. Clearly visible in FIG. 5 are spectral signatures of nitrogen, oxygen, water, and carbon dioxide. Notably, isotopologues of nitrogen and oxygen can also be easily resolved with the instrument, thereby illustrating the exceptionally high spectral resolution afforded by the embodiment of the proposed spectrometer together with its high detection sensitivity. In all measurements discussed in this work, no active detector cooling was employed and only USB power (which is around 0.3 A at 5 V) was supplied for operation of the embodiment of the spectrometer. Advantageously in comparison with spectrometers of related art, despite operating the detector 224 near room temperature, thermal noise (dark shot noise) was negligible because of the tiny detector areas involved. For the IMX183 sensor utilized as the array detector 224, the thermal dark count rate was measured to be 0.02 e⁻/s/pixel at room temperature. Thus, at the overall efficiency reported in Table 1, a light flux of 1000 photons/s through the input slit 208 focused to an area of 100 pixels would result in a signal dominated by signal shot noise. Read noise was also negligible at the exposure times of at least several seconds that are typically relevant for applications such as Raman scattering from gases.

The approximate physical dimensions of the embodiment of the proposed spectrometer were 175 mm×100 mm×75 mm (about 1.3 L) including the microscope objective assembly 230 for focusing onto the input slit 208. While the optical spectra measured and discussed above were obtained with a fixed position of the diffraction grating 216 (that is, with the embodiment 200 that was devoid of a moving component), the skilled artisan would appreciate that a wide range could evidently be covered by allowing the diffraction grating 216 to additionally rotate (about the z-axis as shown in FIG. 2B). In that way, the embodiment similar to the embodiment 200 could cover the entire visible and near-infrared spectral regions (with possibly diminishing efficiencies: for example, at 800 nm the efficiency of the IMX183 sensor 224 drops to about 20% and the efficiency of the grating 216—to below 40%). Alternatively or in addition, a diffraction grating with a higher or lower groove density could be used to reduce or increase the spectral range. In the configuration reported here (that is, the implementation of the embodiment without a moving part), the ratio of the spectral range to the spectral resolution was approximately 2700, which is advantageous to the ratios obtained with the use of commercially available spectrometers. In related implementations that are devoid of a moving part or component, such ratio was in the range from about 2000 to about 3000. For example, for the Thorlabs HG10 spectrometer, the corresponding ratio is 630 (see https://www.thorlabs.com/newgrouppage9.cfm?objectgroup_id=15359) while for the Ibsen photonics EAGLE C-OCT-S spectrometer the corresponding ratio is 1060 (see https://ibsen.com/productinfo/compact-eagle-oct/). While some fiber speckle spectrometers have been reported with spectral range-to-resolution ratios of 3200 (see S. F. Liew, et al., Opt. Lett. 41, 2029-2032, 2016; and H. Chen, et al., Opt. Lett. 48, 4574-4577, 2023), such figures of merit were achieved only in the infrared spectral region and not under light-starved conditions, in stark contradistinction with the present case. Established scientific laboratory instruments such as the Teledyne ISO Plane 320 spectrometer achieve spectral range-to-resolution ratios of only around 1100 (https://www.teledynevisionsolutions.com/products/isoplane/?vertical=tvs-princeton-instruments&segment=tvs) as do models provided by Ocean Optics (see https://www.teledynevisionsolutions.com/products/isoplane/?vertical=tvs-princeton-instruments&segment=tvs) and StellarNet (see https://www.stellamet.us/spectrometers/hr-high-resolution-spectrometers/).

Notably, in an embodiment where the diffractive element (such as a diffraction grating 216) is allowed to rotate, the range of values of the ratio of the spectral range to the spectral resolution can be substantially increased. On the short wavelength end such range is likely to be limited by the transmission of the glass (it will start to attenuate around 400 nm), while on the long wavelength end it is likely to be limited by the grating angle of incidence, the transmission of the objective, and the detector response. In practice, red or near infrared light could be probed with the components specified.

The skilled person now readily appreciates that an embodiment of a bidirectional lens spectrometer is structured according to the idea of the present invention to transmit light acquired by the spectrometer first in one direction (through the lens from the front surface of the lens towards and through the rear surface of the lens) upon propagation of the light from the input of the spectrometer to its diffractive optical component and then in the opposite direction (through the same lens from its rear surface towards and through its front surface) upon propagation of the light that has diffracted at the diffractive optical component. The proposed embodiment offers high spectral resolution (about 1.4 cm⁻¹) over a wide spectral range of about 3800 cm⁻¹ even without the use of moving parts. The embodiment features high detection efficiency (>50% in the green for p-polarized light) and low noise without active cooling. (Indeed, for comparison, spectrometers of related prior art traditionally uses linear array detectors with tall pixels—such as Hamamatsu S390x series with mm pixel height, for example. The thermal noise per pixel is proportional to pixel area. Further, thermoelectric cooling is used to suppress this noise despite the use of large pixels. Accordingly, by working with small pixels and highly focusing optics discussed in reference to implementations of the idea of the invention, the thermal noise was substantially reduced in proportion.)

The employed multi-element camera lens 204 occupied most of the physical space of the spectrometer, and thus the proposed design can likely be miniaturized to occupy even the smaller volume to provide a compact option for high resolution/high spectral range spectroscopy with sensitivity to extremely faint light.

Referring again to the schematic of FIGS. 2A, 2B, the skilled artisan will readily recognize that one of the benefits of the disclosed spectrometer configuration is the ability to operate the reflective diffraction grating 216 very near (or, approximately at) the Littrow angle (or, phrased differently, near or approximately in the Littrow configuration). The Littrow configuration is a specific positioning/orientation of the diffractive grating with respect to the light incident thereon where the light diffracted at the grating travels back substantially exactly along the path of the light incident onto the grating thereby maximizing efficiency of diffraction of the light at the grating (in practice, sometimes in excess of 80%). The angle of incidence of light L onto the grating 216, defined conventionally, is then expressed as θ_{inc}=arcsin(λΛ/2), where λ is the wavelength of light L and Λ is the grating period.

For a fixed wavelength, the dispersion of the diffractive optical element (in the above example—the dispersion of the grating 216) and therefore the resolution of the spectrometer 2 increases with the grating groove density as long as the angle of incidence is smaller than 90 degrees. The discussed embodiment bidirectional lens spectrometer thus can be used to maximize both the spectral resolution and efficiency.

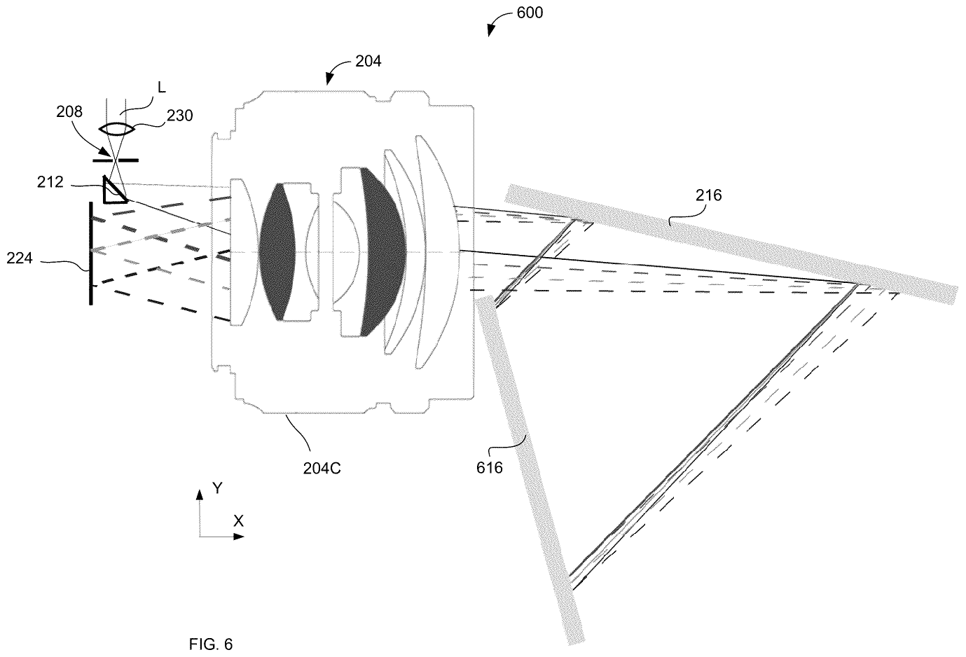

Alternatively, when even higher dispersion is desired and the efficiency of the operation can be sacrificed, then an embodiment of the invention can be appropriately modified—as schematically shown in FIG. 6—by employing “cascaded” diffractive optical elements (diffraction gratings, for example) 216 and 616, each of which is disposed to disperse light incident thereon in the local xy-plane. (The optional PC/processor is not shown for simplicity of illustration.) The configuration depicted in FIG. 6 includes, in addition to the diffractive optical element 216, an auxiliary diffractive optical element 616 disposed to directly receive, from the diffractive optical element 216, the light that has diffracted once at the diffractive optical element 216 and to return said light, in reflection, to the diffractive optical element 216. In other words, the second in line diffractive optical element 616 receives light that has been already dispersed once by the first diffractive optical element 216. This effect is repeated upon the return of light from the element 616 back to the element 216 (then, upon the second interaction with the element 216, the light is delivered through the single lens 204 to the image space. Here, the light received by the spectrometer 600 interacts three times with a surface of a diffractive optics of the optical imaging system prior to a repeated transmission of the light through the single lens 204. The overall, aggregate result of the multiple occurrences of dispersion of light L prior to being received at the detector 224 in this case (and considering the same grating resolving power, that is, the same number of illuminated grating grooves)) can be nearly three times that achieved with the single dispersion event that occurs during the operation of the structure of FIGS. 2A, 2B.

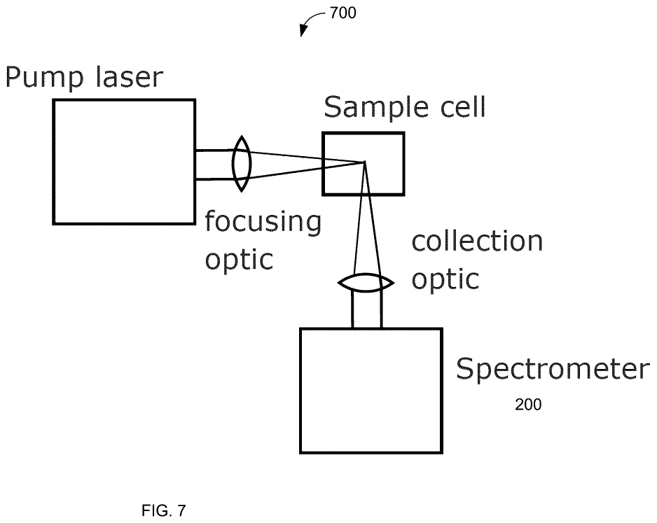

FIG. 7 schematically illustrates an embodiment of the apparatus 700 configured as a Raman gas sensor, which employs the embodiment of the discussed spectrometer. As known is related art, the Raman gas sensor uses laser light scattering (Raman effect) on gas molecules contained in the sample cell to identify and quantify gas mixtures, offering fast, non-destructive, multi-component analysis for industrial, power generation (like natural gas), and environmental monitoring, overcoming limitations of traditional sensors by detecting homonuclear gases (such as oxygen or nitrogen) and providing unique spectral fingerprints for complex mixtures.

As used in this disclosure and unless expressly defined otherwise, the terms “lenslet” and “lens element” are defined to refer to the only, simple, structurally-indivisible and used singly optical component that changes the degree of convergence (or divergence, or collimation) of light passing through or traversing such component. In comparison, the terms “lens”, “group of lenses”, “lens system” and similar terms that may be used interchangeably are defined to refer to a combination or grouping of lenslets or lens elements (which combination may, in a specific case, include only one lens element). As a result, there is no other element or component in between two neighboring to one another lenslets of the single lens: each two sequential lens elements of the single lens or the single lens group are defined to be immediately neighboring to one another.

The term “object space” is conventionally defined and understood as the space located outside of the optical imaging system in question and a portion of which—referred to as an object—is imaged through the optical imaging system onto an image surface (which may substantially coincide with a surface of an optical detector). It is the space (defined in relation to an optical system), in which the objects to be imaged by the system are located. In comparison, a space that is outside of the optical imaging system and consists of points of which each is an image of a corresponding point in the object space—is the “image space”. An object point and its image, formed with the use of the optical imaging system, are considered to be uniquely mapped to one another and, therefore, optically-conjugate to one another.

The term “optically-conjugate” and related terms are understood as being defined by the principal of optical reversibility (according to which light rays will travel along the originating path if the direction of propagation of light is reversed). Accordingly, these terms, as referring to two surfaces, are defined by two surfaces the points of which are imaged one on to another with a given optical system. If an object is moved to the point occupied by its image, then the moved object's new image will appear at the point where the object originated. The points that span optically-conjugate surfaces are referred to and defined as optically-conjugate points. A first layer or pattern is defined as being carried by (or carried on) a given surface or substrate or second layer when the first layer is directly disposed onto the given surface or substrate or second layer, or when the first layer is disposed onto an intervening third layer which, in turn, is disposed onto the given surface or substrate or second layer.

The term “image” refers to and is defined as an ordered representation of detector signals corresponding to spatial positions. For example, an image may be an array of values within an electronic memory, or, alternatively, a visual or visually-perceivable image may be formed on a display device such as a video screen or printer.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes. Other specific examples of the meaning of the terms “substantially”, “about”, and/or “approximately” as applied to different practical situations may have been provided elsewhere in this disclosure.

The expression of the type “element A and/or element B” has the meaning that covers embodiments having element A alone, element B alone, or elements A and B taken together and, as such, is intended to be equivalent to “at least one of: element A and element B”.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention. Within this specification, embodiments have been described in a way that enables a clear and concise specification to be written, but it is intended and will be appreciated that embodiments may be variously combined or separated without parting from the scope of the invention. In particular, it will be appreciated that all features described herein are applicable to all aspects of the invention.

Embodiments of the invention have been described as optionally including a processor controlled by instructions stored in a memory. The memory may be random access memory (RAM), read-only memory (ROM), flash memory or any other memory, or combination thereof, suitable for storing control software or other instructions and data. Those skilled in the art should also readily appreciate that instructions or programs defining the functions and/or operations of an embodiment of the present invention may be delivered to a processor in many forms, including, but not limited to, information permanently stored on non-writable storage media (e.g. read-only memory devices within a computer, such as ROM, or devices readable by a computer/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Furthermore, disclosed aspects, or portions of these aspects, may be combined in ways not listed above. Accordingly, the invention should not be viewed as being limited to the disclosed embodiment(s).

What is claimed is:

1. An optical spectrometer comprising:
a single lens;
an input; and
an optical imaging system including a diffractive optical element and said single lens between the input and the diffractive optical element.

2. An optical spectrometer according to claim 1, wherein the single lens is configured to transmit light acquired by the spectrometer at the input both (i) upon propagation of the light from an object space of the optical imaging system to the diffractive optical element and (ii) upon propagation of the light that has diffracted at the diffractive optical element to an image space of the optical imaging system.

3. An optical spectrometer according to claim 1, wherein a first outer surface of the single lens limits both an object space of the optical imaging system and an image space of the optical imaging system.

4. An optical spectrometer according to claim 1, further comprising an optical detector positioned to be separated from the diffractive optical element by the single lens.

5. An optical spectrometer according to claim 1, wherein the optical imaging system is configured to form an optical image of the input (i) in the light that has diffracted at the diffractive optical element only once or (ii) in the light that has diffracted at the diffractive optical element twice.

6. An optical spectrometer according to claim 1, configured to have the light interact three times with a surface of diffractive optics of the optical imaging system prior to a repeated transmission of the light through the single lens.

7. An optical spectrometer according to claim 1, wherein the optical spectrometer is devoid of a moving component.

8. An optical spectrometer according to claim 1, wherein the diffractive optical element is a diffraction grating oriented to operate substantially in a Littrow configuration.

9. An optical spectrometer according to claim 1, wherein the optical imaging system further comprises an auxiliary diffractive optical element disposed to directly receive, from the diffractive optical element, the light that has diffracted once at the diffractive optical element and to return said light, in reflection, to the diffractive optical element.

10. A Raman gas sensor apparatus comprising the optical spectrometer according to claim 1.

11. A method comprising:
with the use of the optical spectrometer according to claim 1:
transmitting light received at the input through the single lens in a first direction upon propagating the light from the input towards the diffractive optical element; and
traversing the light that has diffracted at the diffractive optical element through the single lens in a second direction,
wherein the first and second directions are opposite to one another.

12. A method according to claim 11, further comprising: receiving the light, which has diffracted at the diffractive optical element and then transmitted through the single lens, at an optical detector of the optical spectrometer.

13. A method according to claim 11, further comprising:
forming an optical image of the light distribution at the input at an optical detector of the spectrometer with a first magnification that is substantially a unit magnification along a first axis that lies in a plane of the optical detector and with a second magnification that is different from the first magnification along a second axis that lies in the plane of the optical detector, the first and second axes being substantially normal to one another.

14. A method according to claim 11, comprising:
transmitting the light from an object space of the optical imaging system into the optical imaging system through a first outer surface of the single lens, and
transmitting the light from the optical imaging system into an image space of the optical imaging system through the first outer surface of the single lens.

15. A method according to claim 11, comprising:
diffracting the light inside the optical imaging system three times prior to transmitting the light from the optical imaging system into an image space of the optical imaging system through a surface of the single lens, wherein the surface of the single lens faces the input.

16. A method according to claim 11, that does not include moving a component of the optical spectrometer.

17. An optical spectrometer according to claim 1, having a ratio of a spectral range to a spectral resolution from about 2000 to about 3000.
